(19) United States
(12) Patent Application Publication
(10) Pub. No.: US 2010/0322844 A1
(43) Pub. Date: Dec. 23, 2010

(54) OZONE SUPPLYING METHOD AND OZONE SUPPLIER

(76) Inventors: Hiroshi SANUI, Fukuoka-shi (JP); Yoshiki Nishiwaki, Kai-shi (JP)

Correspondence Address: NIXON & VANDERHYE, PC, 901 NORTH GLEBE ROAD, 11TH FLOOR, ARLINGTON, VA, 22203, US

(21) Appl. No.: 12/820,413

(22) Filed: Jun. 22, 2010

(30) Foreign Application Priority Data
Jun. 23, 2009 (JP) P2009-148690
Jun. 1, 2010 (JP) P2010-125953

(51) Int. Cl. C01B 13/10; B01J 19/00

(52) U.S. Cl. 423/581; 422/224

(57) ABSTRACT

An ozone supplier 11 of the present invention includes a mixer 1 which dissolves an oxygen-ozone mixed gas in a fluorine-based solvent to produce a mixed solution, an undissolved gas removing device 2 which removes an undissolved gas from the mixed solution, and a deaerator 3 which extracts an ozone-containing gas, which is dissolved in the mixed solution subjected to removal of the undissolved gas, from the mixed solution.

### TECHNICAL FIELD

The present invention relates to an ozone supplying method and an ozone supplier, and more particularly to a method and apparatus which supplies an ozone when an oxidizing, bleaching or surface treatment with ozone is performed.

Priorities are claimed on Japanese Patent Application No. 2009-148690, filed Jun. 23, 2009 and Japanese Patent Application No. 2010-125953, filed Jun. 1, 2010, the contents of which are incorporated herein by reference.

### BACKGROUND ART

Ozone is known as a strong oxidizing agent or a bleaching agent and a method of and an apparatus for treating a powder or a fiber are put into practical use. In such an ozone treatment, an ozone-containing gas containing ozone generated using an oxygen gas as a raw material is used since reaction efficiency usually increases as the ozone concentration in the ozone-containing gas becomes higher.

However, even if ozone is produced by using oxygen as the raw material, the ozone concentration in the ozone-containing gas is limited to about 14 vol % since there are restrictions on ozone generation efficiency, and the remainder is an oxygen gas. Therefore, there has been required an ozone-containing gas in which the oxygen concentration is decreased while maintaining the ozone concentration.

As the method of increasing the ozone concentration in the ozone-containing gas used for the ozone treatment, the method disclosed in Patent Literature 1 is known. Patent Literature 1 discloses a method of concentrating an ozone gas in which ozone is concentrated by adsorbing ozone to silica gel.

### [Citation List]

### [Patent Literature]

### [PTL 1]

Japanese Unexamined Patent Application, First Publication No. 10-213293

### SUMMARY OF INVENTION

### Technical Problem

However, the method disclosed in Patent Literature 1 had a problem that ozone is decomposed by since silica gel when the temperature of an ozone gas to be adsorbed to silica gel is high, resulting in a decrease of the ozone concentration in the ozone gas.

Under these circumstances, the present invention has been made and an object thereof is to provide an ozone supplying method and an ozone supplier, which can decrease the oxygen concentration while maintaining the ozone content in an ozone-containing gas.

### Solution to Problem

To solve these problems,

a first aspect of the present invention is an ozone supplier including:

a mixer which dissolves an oxygen-ozone mixed gas in a fluorine-based solvent to produce a mixed solution,

an undissolved gas removing device which removes an undissolved gas from the mixed solution, and

a deaerator which extracts an ozone-containing gas, which is dissolved in the mixed solution subjected to removal of the undissolved gas, from the mixed solution.

It is preferable that the first aspect of the present invention further include a solvent component removing device which removes the fluorine-based solvent from the ozone-containing gas.

In the first aspect of the present invention, a diluter, which supplies an inert gas to the mixed solution subjected to the removal of the undissolved gas to be diluted, is preferably provided between the undissolved gas removing device and the deaerator.

It is preferable that the first aspect of the present invention further include a pressure controller which controls a pressure when the oxygen-ozone mixed gas is dissolved in the fluorine-based solvent to produce the mixed solution, and a pressure controller which controls a pressure when the ozone-containing gas is extracted from the mixed solution.

It is preferable that the first aspect of the present invention further include a temperature controller which controls a temperature when the oxygen-ozone mixed gas is dissolved in the fluorine-based solvent to produce a mixed solution, and a temperature controller which controls a temperature when the ozone-containing gas is extracted from the mixed solution.

In the first aspect of the present invention, the deaerator preferably includes a bubbling structure which uses an inert gas to bubble the mixed solvent subjected to the removal of the undissolved gas, and an inert gas supplier which supplies the inert gas to the bubbling structure.

In the first aspect of the present invention, a circulating line is preferably provided between the deaerator and the mixer.

A second aspect of the present invention is a multi-stage type ozone supplier including one or more kinds of ozone supplier according to the first aspect of the present invention in a plurality of stages in series.

In the first aspect of the present invention, the fluorine-based solvent is preferably fluorocarbons, fluoroketones, fluoroethers or mixtures thereof.

A third aspect of the present invention is an ozone supplying method including:

dissolving an oxygen-ozone mixed gas in a fluorine-based solvent to produce a mixed solution,

removing an excess gas which remains undissolved in the fluorine-based solvent, and

deaerating the ozone-containing gas dissolved in a liquid component in the mixed solution subjected to removal of the excess gas.

A fourth aspect of the present invention is an ozone supplying method including:

dissolving an oxygen-ozone mixed gas in a fluorine-based solvent under a pressure to produce a mixed solution,

removing an excess gas which remains undissolved in the fluorine-based solvent, and

deaerating ozone-containing gas dissolved in a liquid component by depressurizing the mixed solution subjected to removal of the excess gas.

A fifth aspect of the present invention is an ozone supplying method including:

dissolving an oxygen-ozone mixed gas in a fluorine-based solvent under cooling to produce a mixed solution,

removing an excess gas undissolved in the fluorine-based solvent, and

deaerating the ozone-containing gas dissolved in a liquid component by heating the mixed solution subjected to removal of the excess gas.

### ADVANTAGEOUS EFFECTS OF INVENTION

Since the ozone supplier of the present invention is provided with a mixer which dissolves an oxygen-ozone mixed gas in a fluorine-based solvent, which selectively dissolve ozone, to produce a mixed solution, a mixed solution containing a large amount of ozone dissolved therein can be produced. The undissolved gas component such as oxygen can be removed from the mixed solution by the undissolved gas removing device, and also the ozone-containing gas dissolved in the mixed solution subjected to removal of the undissolved gas component due to a deaerator can be extracted and recovered from the mixed solution. Thus, it is possible to remove the oxygen that is the undissolved gas component and decrease the oxygen concentration in the extracted ozone-containing gas without decomposing ozone contained in the oxygen-ozone mixed gas. When inert gas supplier is provided, since an inert gas can be supplied to the mixed solution, it is possible to freely decrease the ozone concentration while maintaining the ozone content in the ozone-containing gas.

According to the ozone supplying method of the present invention, since a fluorine-based solvent capable of selectively dissolving ozone is used, it is possible to decrease the oxygen concentration in an ozone-containing gas to be produced while maintaining the ozone content in an oxygen-ozone mixed gas by dissolving an oxygen-ozone mixed gas in the fluorine-based solvent to produce a mixed solution, separating a gas component at least once, and deaerating the gas component.

### BRIEF DESCRIPTION OF DRAWINGS

FIG. 1 is a schematic diagram showing an ozone supplier according to the first embodiment of the present invention.

FIG. 2 is a schematic diagram showing an ozone supplier according to the second embodiment of the present invention.

FIG. 3 is a schematic diagram showing an ozone supplier according to the third embodiment of the present invention.

FIG. 4 is a schematic diagram showing an ozone supplier according to the fourth embodiment of the present invention.

FIG. 5 is a schematic diagram showing an ozone supplier according to the fifth embodiment of the present invention.

FIG. 6 is a schematic diagram showing a conventional ozone supplier according to Comparative Example.

### DESCRIPTION OF EMBODIMENTS

An ozone supplying method according to one embodiment to which the present invention is applied will be described in detail below, together with an ozone supplier used therefor, with reference to the accompanying drawings. In the drawings used in the following description, the characterizing portion is sometimes enlarged for easier understanding of characteristic features as a matter of convenience, and thus the dimensional ratio of each constituent element is not necessarily the same as the actual dimensional ratio.

### First Embodiment

First, an ozone supplier according to the first embodiment to which the present invention is applied will be described.

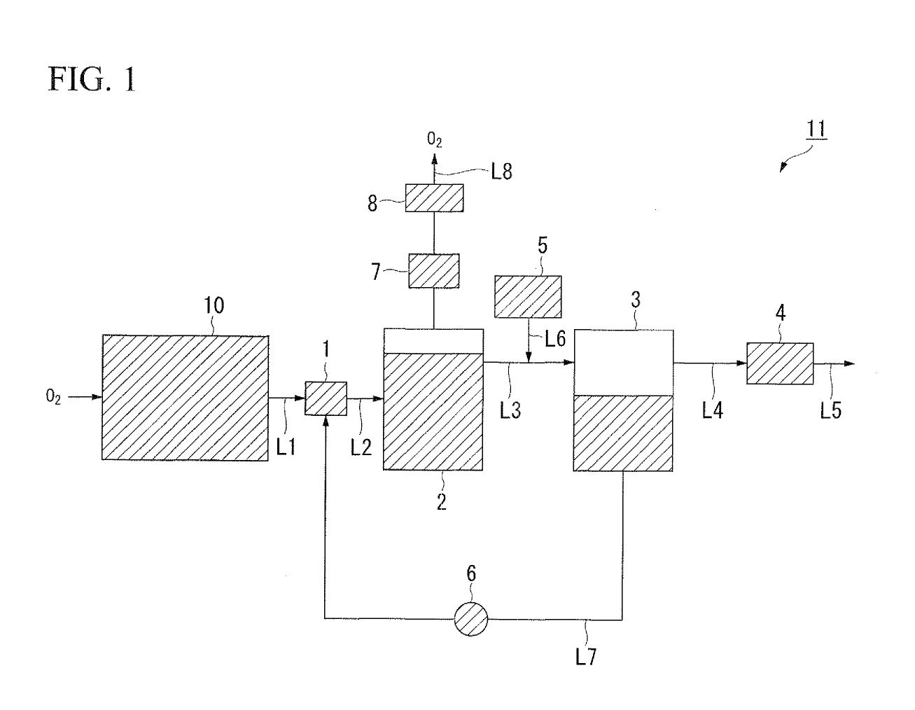

As shown in FIG. 1, an ozone supplier 11 according to the first embodiment of the present invention is generally composed of an ozonizer 10 as an ozone generating apparatus, a mixer (mixing means) 1 as a dissolving apparatus, an oxygen separating tank (undissolved gas removing device) 2 as a removing apparatus for removing a gas component and a deaerating tank (deaerator) 3 as a deaerating apparatus, and is optionally provided with a solvent recovery apparatus (solvent component removing device) 4 and a diluting apparatus (diluter) 5.

More specifically, in the ozone supplier 11, the mixer 1, the oxygen separating tank 2, the deaerating tank 3 and the solvent recovery apparatus 4 are connected in this order between lines L1 to L5 from the ozonizer 10 to outside the ozone supplier 11. In a line L3 between the oxygen separating tank 2 and the deaerating tank 3, a line L6 for introducing an inert gas from the diluting apparatus 5 is provided.

The ozonizer 10 is an apparatus (ozone generator) for generating ozone using oxygen as a raw material. The ozonizer 10 includes, for example, a silent discharge type ozonizer. A mixed gas of oxygen and ozone (oxygen-ozone mixed gas) is produced by this ozonizer 10. There is no particular limitation on the ozone concentration in the oxygen-ozone mixed gas. For example, an oxygen-ozone mixed gas having the ozone concentration within a range from 6 to 10 vol % is preferably used. While the ozone supplier 11 of the present embodiment shows an example in which an ozonizer 10 is embedded, it is also possible to supply the oxygen-ozone mixed gas from the ozone generating apparatus disposed outside the ozone supplier 11.

The mixer 1 is an apparatus used for mixing an oxygen-ozone mixed gas generated in the ozonizer 10 with a fluorine-based solvent and dissolving the oxygen-ozone mixed gas in the fluorine-based solvent to produce a mixed solution. To the mixer 1, a line L1 for introducing an oxygen mixed gas produced by the ozonizer 10 and a line L2 for sending the mixed solution thus produced to the oxygen separating tank 2. The mixer 1 includes, for example, a static mixer and an aspirator. It is preferred to perform mixing and dissolution treatments under a pressure of 0.05 to 1.0 MPaG, and preferably 0.1 to 0.3 MPaG in the mixer 1 so as to increase the amount of the oxygen-ozone mixed gas to be dissolved in the mixed solution.

The fluorine-based solvent selectively dissolve ozone from the mixed gas of oxygen and ozone, and examples thereof include fluorocarbons, fluoroketones, fluoroethers or mixtures thereof. It is preferred that the fluorine-based solvent used in the present embodiment exhibits a liquid state at normal temperature.

Examples of the fluorocarbons include hydrofluorocarbon such as pentafluoropropane (CHF₂CH₂CF₃); and perfluorocarbon such as perfluoropentane (C₅F₁₂) or perfluorohexane (C₆F₁₄).

Examples of the fluoroketones include perfluoroketone such as 1,1,1,2,2,4,5,5,5-nonafluoro-4-(trifluoromethyl)-3-pentanone (C₆F₁₂O).

Examples of the fluoroethers include C₄F₉OC₂H₅.

Of the fluorine-based solvents described above, perfluorocarbons (C₅F₁₂, C₆F₁₄, etc.) are particularly preferred since the combustion prevention effect is exerted even when remained in the produced ozone-containing gas described hereinafter.

For specific example, perfluorohexane (C₆F₁₄) has the property in that oxygen of about 0.6 L is dissolved in a liquid perfluorohexane of 1 L at normal temperature and about ozone of 2 L is dissolved. Accordingly, perfluorohexane selectively dissolve ozone.

The oxygen separating tank 2 is a removing apparatus for removing an excess gas component which is not dissolved in the mixed solution, and is provided at the downstream side of the mixer 1. The oxygen separating tank 2 is provided with a line L2 for supplying the mixed solution produced in the mixer 1 to the oxygen separating tank 2, a line L3 for sending the mixed solution subjected to the removal of the undissolved gas to the deaerating tank 3, and an exhaust line L8 for discharging the gas component separated and removed from the mixed solution out of the system. In the exhaust line L8, a solvent component recovery apparatus 7 and an ozone decomposing apparatus 8 are provided.

The mixed solution supplied through the line L2 and an undissolved gas component are introduced into the oxygen separating tank 2, where the introduced gas component can be removed.

Since the amount of ozone to be dissolved in the fluorine-based solvent of the mixed solution of is more than that of oxygen, as described above, excess oxygen which was not dissolved in fluorocarbon is mainly separated in the oxygen separating tank. A portion of ozone is also entrained with oxygen and separated. The separated and removed gas component is discharged out of the oxygen separating tank through the exhaust line L8, and then discharged out of the system of the ozone supplier 11 through the solvent component recovery apparatus 7 and the ozone decomposing apparatus 8.

Furthermore, the oxygen separating tank 2 may be provided with a gas dissolving apparatus such as baffle plate so as to promote dissolution of ozone in the fluorine-based solvent.

The deaerating tank 3 is a deaerating apparatus for extracting the ozone-containing gas dissolved in the mixed solution subjected to the removal of the undissolved gas from the mixed solution, and is provided at the downstream side of the oxygen separating tank 2. A line L3 for supplying the mixed solution, from which the undissolved gas was separated and removed by the oxygen separating tank 2, to the deaerating tank 3, a line L4 for deriving an ozone-containing gas produced by deaeration and a circulating line L7 for circulating the fluorine-based solvent after deaerating to the mixer 1 using a pump 6 are connected to the deaerating tank 3.

The deaerating tank 3 is a pressure release type tank and the pressure inside the deaerating tank 3 is adjusted to the pressure lower than that inside the oxygen separating tank 2. In the deaerating tank 3, a spray nozzle (not shown) for ejecting the mixed solution supplied through the line L3 is provided. It is possible to deaerate the gas component dissolved in the mixed solution by ejecting the mixed solution into the tank via this spray nozzle. Since a large amount of oxygen is selectively separated and removed in the oxygen separating tank 2, as described above, it is possible to produce an ozone-containing gas in which the oxygen concentration is decreased while maintaining the ozone concentration.

The ozone supplier 11 of the present embodiment is provided with a pressure controlling apparatus (pressure controller) (not shown). The pressure controlling apparatus is not particularly limited as long as it can maintain or control to a desired pressure when an oxygen-ozone mixed gas is dissolved in a fluorine-based solvent to produce a mixed solution, and when an ozone-containing gas is extracted from the mixed solution. In the present embodiment, for example, a pressure controlling valve is exemplified as the pressure controlling apparatus.

More specifically, the oxygen separating tank 2 is provided with a pressure controlling valve as the pressure controlling apparatus. It is possible to maintain the pressure inside the mixer 1 increased by an oxygen-ozone mixed gas supplied from the ozonizer 10 and a circulating solvent (fluorine-based solvent) at a predetermined pressure by this pressure controlling valve. In other words, it is possible to maintain the pressure inside the mixer 1 at optimum pressure when the oxygen-ozone mixed gas is dissolved in the fluorine-based solvent to produce a mixed solution by the pressure controlling valve.

Similarly, the deaerating tank 3 is provided with a pressure controlling valve as the pressure controlling apparatus. It is possible to maintain the pressure inside the deaerating tank 3 increased by a circulating solvent (fluorine-based solvent) flowed from the oxygen separating tank 2 and the deaerated gas at a predetermined pressure by this pressure controlling valve. In other words, it is possible to separate an ozone-containing gas while maintaining the pressure inside the deaerating tank 3 at an optimum pressure when the ozone-containing gas is extracted from the mixed solution by the pressure controlling valve.

As the pressure controlling apparatus, a pressurizing apparatus (pressurizing means) or a depressurizing apparatus (depressurizing means) capable of positively controlling the pressure may be used.

In order to facilitate dissolution of the oxygen-ozone mixed gas in the fluorine-based solvent, the pressure (i.e. pressure inside the mixer 1) is preferably maintained at a high pressure when the oxygen-ozone mixed gas is dissolved in the fluorine-based solvent to produce a mixed solution. In contrast, when the ozone-containing gas is extracted from the mixed solution, the pressure (i.e. pressure inside the deaerating tank 3) may be set at the pressure lower than that in the case where the oxygen-ozone mixed gas is dissolved in the fluorine-based solvent.

The pressure inside the deaerating tank 3 is preferably controlled to the pressure which is slightly higher than an atmospheric pressure. Specifically, the pressure is preferably maintained at or controlled to the pressure which is at least 0.05 MPaG higher than the atmospheric pressure.

When the oxygen-ozone mixed gas is dissolved in the fluorine-based solvent in the mixer 1, the pressure is preferably maintained at or controlled to the pressure which is at least 0.05 MPaG higher than that inside the deaerating tank 3, and more preferably the pressure which is at least 0.3 MPaG higher than the pressure.

The solvent recovery apparatus 4 is provided at the downstream side of the deaerating tank 3 so as to remove the fluorine-based solvent component after deaerating from the ozone-containing gas. To the solvent recovery apparatus 4, a line L4 for supplying an ozone-containing gas after deaerating and a line L5 for discharging the ozone-containing gas subjected to the removal of the fluorine-based solvent out of the ozone supplier 11 are connected. It is possible to remove and recover a fluorine-based solvent component from the ozone-containing gas and to recycle the ozone-containing gas by providing this solvent recovery apparatus 4.

The diluting apparatus 5 is provided between the oxygen separating tank 2 and the deaerating tank 3 so as to supply an inert gas to the mixed solution subjected to the removal of the undissolved gas. In the line L3 between the oxygen separating tank 2 and the deaerating tank 3, a line L6 for introducing an inert gas from the diluting apparatus 5 is provided. An inert gas can be added to the mixed solution derived from the oxygen separating tank 2 by this line L6. As described above, it is possible to prevent a high-concentration ozone-containing gas from producing in the deaerating tank 3 by diluting the mixed solution with the inert gas.

As described above, when the fluorine-based solvent component is removed from the ozone-containing gas discharged from the deaerating tank 3 by the solvent recovery apparatus 5, an inert gas may be further supplied in the amount corresponding to that of the fluorine-based solvent component removed as required.

There is no particular limitation on the kind of the inert gas. Specifically, an argon (Ar) gas, a helium (He) gas and a nitrogen gas (N₂) are exemplified. Of these gases, a nitrogen gas is preferred in view of the cost.

The ozone supplying method using the ozone supplier 11 of the present embodiment will be described below.

The ozone supplying method of the present embodiment is generally composed of the steps of dissolving an oxygen-ozone mixed gas in a fluorine-based solvent to produce a mixed solution, removing excess gas from a liquid component of the mixed gas thus produced, and deaerating the ozone-containing gas dissolved in the liquid component in the mixed solution subjected to the removal of the excess gas. The ozone supplying method is characterized by deaerating the ozone-containing gas dissolved in the liquid component by depressurizing the mixed solution subjected to the removal of the excess gas.

Specifically, first, an oxygen-ozone mixed gas produced by an ozonizer 10 is supplied to a mixer 1 through a line L1. Then, in the mixer 1, the oxygen-ozone mixed gas is dissolved in a fluorine-based solvent to produce a mixed solution. In order to increase the amount of the oxygen-ozone mixed gas to be dissolved in the fluorine-based solvent, mixing and dissolution treatments by the mixer 1 are preferably performed under pressure.

Then, the mixed solution is supplied to an oxygen separating tank 2. In the oxygen separating tank 2, the excess gas component is separated and removed from the supplied mixed solution and the undissolved excess gas component. The gas component thus removed is discharged out of the oxygen separating tank 2 through a line L8 and then discharged out of the system of the ozone supplier 11 through a solvent component recovery apparatus 7 and an ozone decomposing apparatus 8.

Then, the mixed solution subjected to the removal of the excess gas component is supplied to a deaerating tank 3 from the oxygen separating tank 2. In this case, in a line L3 from the oxygen separating tank 2 to the deaerating tank 3, an inert gas is added to the mixed solution from a diluting apparatus 5.

Next, the mixed solution containing the inert gas added therein is ejected into the deaerating tank 3 as a pressure release type tank using a spray nozzle. Thus, the gas component dissolved in the mixed solution can be deaerated. The pressure of the deaerating tank 3 may be lower than that in the case of dissolution. When the pressure of the oxygen separating tank 2 is 0.05 MPaG or higher, the pressure may be controlled to nearly atmospheric pressure. After deaeration, the fluorine-based solvent can be recycled after returning to the mixer 1 using a pump 6. When the fluorine-based solvent component existing in the ozone-containing gas supplied through the line L4 is not required, it may be removed in a solvent recovery apparatus 4. In such a manner, it is possible to produce an ozone-containing gas in which the oxygen concentration is decreased while maintaining the ozone concentration. The ozone-containing gas supplied by the method of the present embodiment contains ozone, oxygen, a fluorine-based solvent and an inert gas, and the concentration of each component such as ozone can be appropriately adjusted.

As described above, the ozone supplier 11 of the present embodiment is provided with the mixer 1 in which the oxygen-ozone mixed gas is dissolved in the fluorine-based solvent to produce a mixed solution. The fluorine-based solvent can produce a mixed solution containing a larger amount of ozone dissolved therein than that in the case of using water as a solvent. It is also possible to remove the undissolved oxygen and ozone from the mixed solution by the oxygen separating tank 2 and to recover the ozone-containing gas dissolved in the mixed solution by the deaerating tank 3. Most of the fluorine-based solvents are inert and incombustible and are therefore reacts slightly with ozone. Therefore, as compared with the case where ozone is adsorbed to silica gel, there is no fear of decomposition of ozone, and a decrease in the ozone concentration in the ozone-containing gas.

According to the ozone supplier 11 of the present embodiment, a large amount of ozone can be dissolved in the fluorine-based solvent since the oxygen separating tank 2 is provided with a pressure controlling valve as the pressure controlling apparatus and can maintain the pressure inside the oxygen separating tank 2 at a high pressure.

Since the deaerating tank 3 is provided with a pressure controlling valve as the pressure controlling apparatus and the pressure can be controlled to the pressure lower than that inside the oxygen separating tank 2, the ozone-containing gas dissolved in the mixed solution can be easily deaerated and recovered.

Since the ozone supplier 11 of the present embodiment is provided with a diluting apparatus 5, an inert gas can be added to the mixed solution discharged from the oxygen separating tank 2. As described above, it is possible to prevent a high-concentration ozone-containing gas from producing as a result of dilution of the ozone-containing gas produced in the deaerating tank 3 by adding an inert gas to the mixed solution before supplying to the deaerating tank 3. It is also possible to freely adjust the ozone concentration in the ozone-containing gas recovered from the deaerating tank 3.

According to the ozone supplying method of the present embodiment, since a fluorine-based solvent capable of selectively dissolving ozone is used, it is possible to decrease the oxygen concentration in an ozone-containing gas to be produced while maintaining the ozone content in an oxygen-ozone mixed gas by dissolving the oxygen-ozone mixed gas in the fluorine-based solvent to produce a mixed solution, separating a gas component at least once, and deaerating the gas component. According to the method of the present embodiment, it is possible to appropriately add a fluorine-based solvent component and an inert gas to the ozone-containing gas to be produced and to appropriately adjust the concentration. It is also possible to easily adjust the gas component other than ozone while maintaining the ozone concentration in the ozone-containing gas.

### Second Embodiment

The second embodiment to which the present invention is applied will be described below.

The ozone supplier of the present embodiment has a configuration which is different from that of the ozone supplier 11 of the first embodiment. Therefore, with respect to the ozone supplier of the present embodiment, the same numerals are used for constituent elements identical to those of the first embodiment, and repetitive descriptions are omitted.

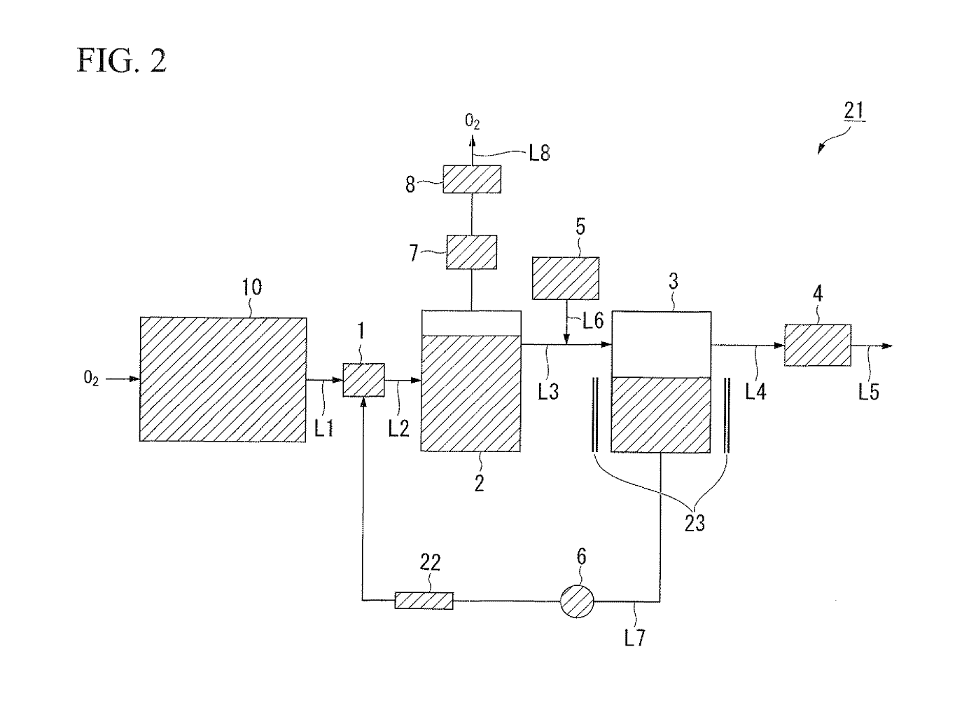

As shown in FIG. 2, an ozone supplier 21 of the present embodiment has a configuration provided with temperature controlling apparatuses 22, 23, whereas, the ozone supplier 11 of the first embodiment is provided with a pressure controlling apparatus (not shown). The temperature controlling apparatuses 22, 23 are not particularly limited as long as the temperature inside the mixer 1 or deaerating tank 3, or the temperature of the solvent circulating therein can be maintained at or controlled to a predetermined pressure.

Specifically, in the ozone supplier 21 of the present embodiment, a cooling apparatus 22 is provided in a circulating line L7 from the deaerating tank 3 to the mixer 1 as a temperature controlling apparatus for controlling the temperature of the solvent circulating in the mixer 1. It is possible to supply a fluorine-based solvent cooled after cooling the fluorine-based solvent after deaerating in the deaerating tank 3 to the mixer 1 by this cooling apparatus 22. Namely, it is possible to control to an optimum temperature when the oxygen-ozone mixed gas is dissolved in the fluorine-based solvent to produce a mixed solution.

The temperature controlling apparatus of the present embodiment may be directly attached to the mixer 1. The cooling apparatus 22 of the present embodiment is provided at the downstream side of the pump 6. However, there is no particular limitation and the cooling apparatus may be provided at any position of the circulating line L7.

As shown in FIG. 2, in the ozone supplier 21 of the present embodiment, the deaerating tank 3 is provided with a heater 23 as a temperature controlling apparatus for controlling the temperature of the solvent circulating in the deaerating tank 3. The gas component dissolved in the mixed solution can be deaerated and recovered by heating the mixed solution supplied from the oxygen separating tank 2 using this heater 23. Namely, it is possible to control to an optimum temperature when the ozone-containing gas is extracted from the mixed solution.

According to the ozone supplier of the present embodiment, dissolution and deaeration of ozone are performed by temperature control, whereas, dissolution and deaeration of ozone are performed by pressure control in the oxygen separating tank 2 and the deaerating tank 3 according to the ozone supplying method of the first embodiment. Usually, as the temperature of a liquid decreases, the amount of a gas to be dissolved in the liquid increases. In the present embodiment, first, an oxygen-ozone mixed gas is dissolved in a fluorine-based solvent cooled in the mixer 1. Then, the excess gas component is separated and removed in the oxygen separating tank 2. Then, the gas component existing in the fluorine-based solvent is deaerated by heating a liquid component in a deaerating tank 3. Specifically, according to the temperature operation in the present embodiment, the temperature is controlled to 0° C. when the oxygen-ozone mixed gas is introduced into the mixer 1, and then the temperature is controlled to 30° C. when deaerating is performed in the deaerating tank 3.

As described above, according to the ozone supplier 21 and the ozone supplying method of the present embodiment, the effects similar to those of the first embodiment can be obtained. In the present embodiment, simplification and miniaturization of the apparatus can be performed by using temperature controlling apparatuses (cooling apparatus 22, heater 23) in place of the pressure controlling apparatus.

### Third Embodiment

The third embodiment to which the present invention is applied will be described below.

The ozone supplier of the present embodiment has a configuration which is different from those of the ozone suppliers 11, 21 of the first and second embodiments. Therefore, with respect to the ozone supplier of the present embodiment, the same numerals are used for constituent elements identical to those of the first and second embodiments, and repetitive descriptions are omitted.

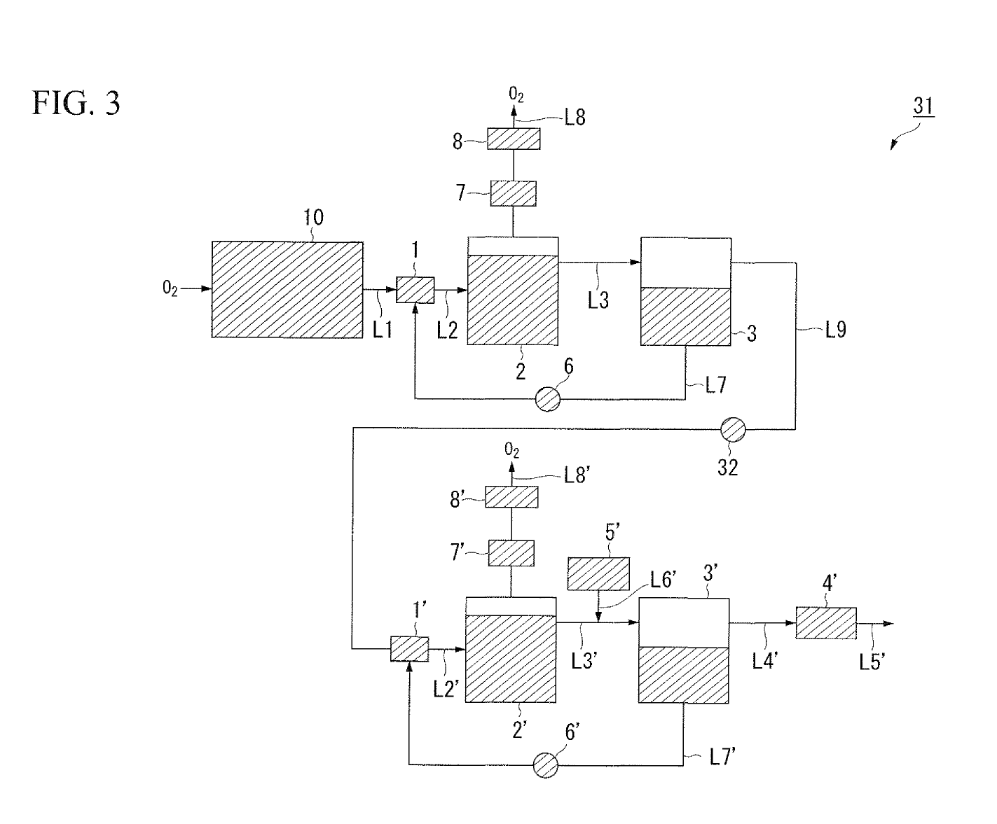

As shown in FIG. 3, the ozone supplier 31 of the present embodiment has such a configuration that two ozone suppliers 11 of the first embodiment are connected in series (hereinafter referred to two stage configuration).

Specifically, the ozone supplier 31 of the present embodiment is provided with a line L9 which connects a deaerating tank 3 at the first stage to a mixer 1′ at the second stage. In the line L9, a booster 32 such as a compressor is provided and enables supply of the ozone-containing gas recovered from the deaerating tank 3 at the first stage to the mixer 1′ at the second stage by pressurizing. The ozone supplier 31 is provided with a solvent recovery apparatus 4 and a diluting apparatus 5 only at the second stage.

The ozone supplying method of the present embodiment is basically the same as that of the first embodiment having a single-stage configuration. The oxygen concentration in the ozone-containing gas can be further decreased by using the ozone supplier 31.

As described above, according to the ozone supplier 31 and the ozone supplying method of the present embodiment, the effects similar to those of the first embodiment can be obtained. In the present embodiment, the oxygen concentration in the ozone-containing gas can be further decreased by using the ozone supplier 31 of two stage configuration.

### Fourth Embodiment

The fourth embodiment to which the present invention is applied will be described below.

The ozone supplier of the present embodiment has a configuration which is different from those of the ozone suppliers 11, 21, 31 of the first to third embodiments. Therefore, with respect to the ozone supplier of the present embodiment, the same numerals are used for constituent elements identical to those of the first to third embodiments, and repetitive descriptions are omitted.

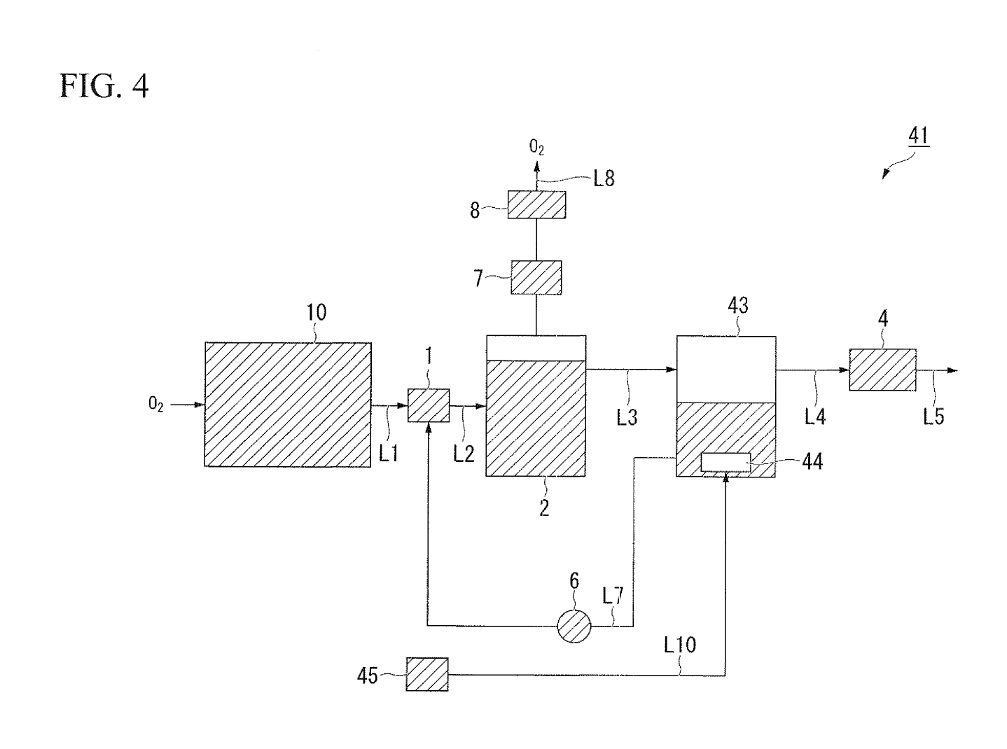

As shown in FIG. 4, the ozone supplier 41 of the present embodiment is different from the ozone suppliers 11, 21, 31 of the first to third embodiments in that the deaerating tank (deaerator) 43, which is a deaerating apparatus, ejects the mixed solution through the spray nozzle into the tank, that the bubbling is performed from the lower part of the tank, and that the diluting apparatus 5 and the line L6 are removed.

Specifically, the ozone supplier 41 of the present embodiment is characterized in that the deaerating tank 43 is provided with the spray nozzle, which is not shown in figure, in the same manner as the deaerating tank 3 of the first embodiment and the structure (bubbling structure 44), which uses an inert gas to bubble, at the lower part of the deaerating tank 43. In addition, the deaerating tank 43 is provided with the inert gas supplying apparatus (inert gas supplier) 45 which supply an inert gas such as a nitrogen gas to the bubbling structure through the line L10. This bubbling structure 44 uses an inert gas to bubble the mixed solution in the deaerating tank 43, and therefore, it is possible to more efficiently deaerate the gas component (i.e. ozone) dissolved in the mixed solvent. Herein, the deaerating tank 43 has the same configuration as the deaerating tank 3 of the first embodiment except for being provided with the bubbling structure 44 and the inert gas supplying apparatus 45.

As described above, according to the ozone supplier 41 and the ozone supplying method of the present embodiment, the effects similar to those of the first embodiment can be obtained. In the present embodiment, the ozone gas can be more efficiently deaerated by the bubbling structure 44 in comparison with the case where ozone is deaerated by only controlling a pressure.

### Fifth Embodiment

The fifth embodiment to which the present invention is applied will be described below.

The ozone supplier of the present embodiment has a configuration which is different from those of the ozone suppliers 11, 21, 31, 41 of the first to fourth embodiments. Therefore, with respect to the ozone supplier of the present embodiment, the same numerals are used for constituent elements identical to those of the first to fourth embodiments, and repetitive descriptions are omitted.

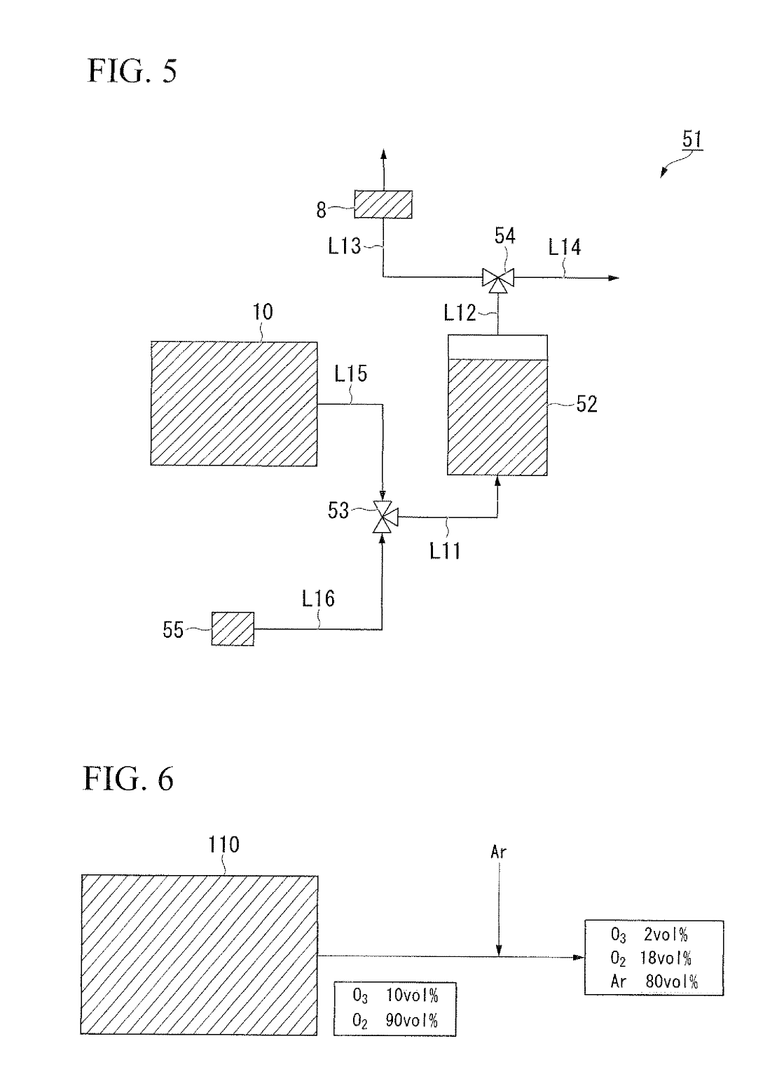

As shown in FIG. 5, the ozone supplier 51 of the present embodiment is different from the ozone suppliers 11, 21, 31, 41 of the first to fourth embodiments in that the common absorption tank 52 is used as the oxygen separation tank 2 and the deaerating tank 3(43).

Specifically, the ozone supplier 51 of the present embodiment is basically comprised of the ozonizer 10, the absorption tank 52, the entrance-switching three-way valve 53 that is provided at the entrance side of the absorption tank 52, the exit-switching three-way valve 54 that is provided at the exit side of the absorption tank 52, and the inert gas supplying apparatus 55.

The absorption tank 52 is provided with the pressure controlling apparatus (not shown in figure). The lower part of the absorption tank 52 is connected with the entrance-switching three-way valve 53 through the line L11. Herein, the line L11 is for bubbling. Meanwhile, the upper part of the absorption tank 52 is connected with the exit-switching three-way valve 54 through the line L12.

The entrance-switching three-way valve 53 is connected with the line L15, which is provided between the ozonizer 10 and the entrance-switching three-way valve 53, and the line L16, which is provided between the inert gas supplying apparatus 55 and the entrance-switching three-way valve 53, in addition to the aforementioned line L11. By switching the line L15 and the line L16, it is possible to supply each of the oxygen-ozone mixed gas generated in the ozonizer 10 and the inert gas supplied from the inert gas supplying apparatus 55 to the absorption tank 52.

The exit-switching three-way valve 54 is connected with the line L13, which is provided between the ozone decomposing apparatus 8 and the exit-switching three-way valve 54, and the line L14, which is the production gas line, in addition to the aforementioned line L12. Accordingly, the line L13 and line L14 can be switched depending on the gas component discharged from the absorption tank 52.

Hereunder is a description of the ozone supplying method of the present embodiment that uses the ozone supplier 51.

Firstly, the entrance-switching three-way valve 53 is switched so as to connect the line L15 with the line L11, and the exit-switching three-way valve 54 is switched so as to connect the line L12 with the line L13.

Next, the oxygen-ozone mixed gas generated in the ozonizer 10 is introduced into the absorption tank 52, and the oxygen-ozone mixed gas is dissolved in the fluorine-based solvent to produce the mixed solvent. Also, an excess gas component, which is not dissolved, is removed out of the system.

Herein, the supply pressure of the oxygen-ozone mixed gas can be atmosphere pressure, but the amount of ozone to be dissolved in the fluorine-based solvent increases as the supply pressure increases. Therefore, the supply pressure is preferably within a range from atmosphere pressure to 0.2 MPaG.

Next, the entrance-switching three-way valve 53 is switched so as not to connect the line L11 with the lines L15 and L16 at the stage where the ozone is sufficiently dissolved in the fluorine-based solvent. Then, the exit-switching three-way valve 54 is switched so as to connect the line L12 with the line L14, and the entrance-switching three-way valve 53 is switched so as to connect the line L16 with the line L11. Accordingly, the ozone-containing inert gas can be produced.

Herein, the supply pressure of the inert gas can be atmosphere pressure, but the deaeration of ozone from the fluorine-based solvent can be efficiently performed as the supply pressure increases. Therefore, the supply pressure is preferably within a range from atmosphere pressure to 0.2 MPaG.

As described above, according to the ozone supplier 51 and the ozone supplying method of the present embodiment, the ozone-containing gas can be produced by using one absorption tank 52.

The technical scope of the present invention is not limited to aforementioned embodiments, and many modifications may be made thereto without departing from the spirit and scope of the present invention. While the third embodiment has such a configuration that dissolution and deaeration of ozone are performed in the first and second stages, the configuration may be replaced by the configuration that dissolution and deaeration of ozone are performed by using temperature control alone, or using pressure control and temperature control in combination.

While the aforementioned third embodiment has a configuration that an ozone supplier 31 has a two stage configuration, the configuration may be replaced by a configuration of three of more stage. A plural stage type ozone supplier may have a configuration that a pressure operation or a temperature operation is used alone, or a pressure operation and a temperature operation may be optionally used in combination.

### EXAMPLES

Specific examples will be shown below.

### Experiment 1

### Example 1

Using a supplier shown in FIG. 1, an ozone-containing gas was produced.

Specifically, the oxygen-ozone mixed gas obtained by generating 10 vol % ozone and 90 vol % oxygen at 0.11 MPaG was dissolved in liquefied perfluorohexane (C₆F₁₄) at 15° C. and then a nitrogen (N₂) gas was added. Then, ozone was deaerated by depressurizing to 0.01 MPaG. The nitrogen gas was added so that the sum of the ozone concentration and the oxygen concentration in the ozone-containing gas after dilution becomes 21% which is nearly the same as the oxygen concentration in air in terms of oxygen.

The component ratio of the ozone-containing gas after dilution is shown in Table 1.

### Example 2

Using a supplier shown in FIG. 3, an ozone-containing gas was produced.

Specifically, the oxygen-ozone mixed gas obtained by generating 10 vol % ozone and 90 vol % oxygen at 0.11 MPaG was dissolved in liquefied perfluorohexane (C₆F₁₄) at 15° C. Then, ozone was deaerated by depressurizing to 0.01 MPaG.

The ozone-oxygen-perfluorohexane mixed gas obtained in the first stage before dilution was pressurized to 0.11 MPaG and dissolved in liquefied perfluorohexane at 15° C., and then ozone was deaerated by depressurizing to 0.01 MPaG. Before depressurizing at the second stage, a nitrogen gas was added so that the sum of the ozone concentration and the oxygen concentration in the ozone-containing gas in the ozone-containing gas after dilution becomes about 21% in terms of oxygen.

The component ratio of the ozone-containing gas after dilution is shown in Table 1.

### Comparative Example

For comparison, using a conventional ozone supplier apparatus 110 shown in FIG. 6, an ozone-containing gas was produced.

Specifically, the oxygen-ozone mixed gas obtained by generating 10 vol % ozone and 90 vol % oxygen was diluted with nitrogen as an inert gas thereby decreasing the oxygen concentration. In this case, the mixed gas was diluted with nitrogen so that the sum of the ozone concentration and the oxygen concentration in the ozone-containing gas in the ozone-containing gas after dilution becomes about 21% in terms of oxygen.

The component ratio before and after dilution is shown in Table 1.

TABLE 1

| Gas | Ozone | Oxygen | Perfluorohexane | Nitrogen |
|---|---|---|---|---|
| components | (vol %) | (vol %) | (vol %) | (vol %) |
| Example 1 | 5 | 13.5 | 6.5 | 75 |
| Example 2 | 9.1 | 7.3 | 5.8 | 77.8 |
| Comparative | 10 | 90 | — | — |
| Example | | | | |
| (before | | | | |
| dilution) | | | | |
| Comparative | 2 | 18 | — | 80 |
| Example | | | | |
| (after dilution) | | | | |

As shown in Table 1, in the case of comparing the ozone concentration when the sum of the ozone concentration and the oxygen concentration after dilution with nitrogen is 21%, the ozone concentration of Comparative Example using a conventional ozone supplier was 2 vol %, whereas, the ozone concentration of Example 1 was 5 vol %. Therefore, it was confirmed that the present invention makes it possible to increase the ozone concentration in the ozone-containing gas and to decrease the oxygen concentration.

The ozone concentration of Example 2 was 9.1% which is more than that of Example 1. Therefore, it was confirmed that the ozone concentration in the ozone-containing gas can be further increased by using a multi-stage type ozone supplier of the present invention.

### Experiment 2

### Example 3

The amount of the ozone that was actually dissolved in the liquid perfluorohexane (C₆F₁₄) was measured in the aforementioned fifth embodiment.

Specifically, the ozone supplier 51 shown in FIG. 5 was used, and the oxygen-ozone mixed gas in the ozonizer 10 was supplied to the absorption tank 52 that was filled with the liquid perfluorohexane. The pressure in the absorption tank 52 during the supply was 0.06 MPaG. After the oxygen-ozone mixed gas was supplied for more than 30 minutes, both of the entrance-switching three-way valve 53 and the exit-switching three-way valve 54 were closed, and the dissolution was completed.

The absorption tank 52 was stabilized for 10 minutes. Then, the small amount of liquid perfluorohexane was extracted, and the amount of the dissolved ozone was measured. The amount of the dissolved ozone was 143 g/m³.

Herein, the measurement of the amount of the dissolved ozone was performed by the titration method using potassium iodide. Specifically, the extracted liquid perfluorohexane was mixed with the potassium iodide solution of 0.1 mol/L and was prepared to be acid with sulfuric acid. The sodium thiosulfate solution of 0.01 mol/L was titrated thereto, and the titration amount of the sodium thiosulfate was used to calculate the amount of the dissolved ozone.

### Example 4

On the completion of the operations in the aforementioned Example 3, the exit-switching three-way valve 54 was opened to reduce the pressure in the absorption tank 52 to atmosphere pressure. The amount of the dissolved ozone was measured in the same manner as the aforementioned, and it was 124 g/m³.

### Example 5

The same operations as in the aforementioned Example 3 were performed until the dissolution of the ozone followed by the stabilization. Then, the entrance-switching three-way valve 53 was switched to the inert gas side, and the nitrogen gas was supplied for 10 minutes. The pressure in the absorption tank 52 during the supply was 0.06 MPaG.

Thereafter, the supply of the nitrogen gas was stopped, and the pressure in the absorption tank 52 was reduced to atmosphere pressure. Then, the small amount of liquid perfluorohexane was extracted, and the amount of the dissolved ozone was measured in the same manner as the aforementioned. The amount of the dissolved ozone was 23 g/m³.

Therefore, it was confirmed that the deaeration of ozone due to a nitrogen gas was much more efficient than the deaeration of ozone due to the depressurizing operation to atmosphere pressure. Also, it was confirmed that the concentrated ozone-containing inert gas atmosphere can be produced.

### REFERENCE SIGNS LIST

1: Mixer (mixing means)
2: Oxygen separating tank (undissolved gas removing device)
3: Deaerating tank (deaerator)
4: Solvent recovery apparatus (solvent component removing device)
5: Diluting apparatus (diluter)
6: Pump
7: Solvent component recovery apparatus
8: Ozone decomposing apparatus
10: Ozonizer
11, 21, 31, 41, 51: Ozone supplier
22: Cooling apparatus (temperature controller)
23: Heater (temperature controller)
32: Compressor
44: Bubbling structure
45: Inert gas supplier (inert gas supplying means)
L7: Circulating line

1. An ozone supplier comprising:
a mixer which dissolves an oxygen-ozone mixed gas in a fluorine-based solvent to produce a mixed solution,
an undissolved gas removing device which removes an undissolved gas from the mixed solution, and
a deaerator which extracts an ozone-containing gas, which is dissolved in the mixed solution subjected to removal of the undissolved gas, from the mixed solution.

2. The ozone supplier according to claim 1, further comprising a solvent component removing device which removes the fluorine-based solvent from the ozone-containing gas.

3. The ozone supplier according to claim 1, wherein a diluter, which supplies an inert gas to the mixed solution subjected to the removal of the undissolved gas to be diluted, is provided between the undissolved gas removing device and the deaerator.

4. The ozone supplier according to claim 1, further comprising:
a pressure controller which controls a pressure when the oxygen-ozone mixed gas is dissolved in the fluorine-based solvent to produce the mixed solution, and
a pressure controller which controls a pressure when the ozone-containing gas is extracted from the mixed solution.

5. The ozone supplier according to claim 1, further comprising:
a temperature controller which controls a temperature when the oxygen-ozone mixed gas is dissolved in the fluorine-based solvent to produce a mixed solution, and
a temperature controller which controls a temperature when the ozone-containing gas is extracted from the mixed solution.

6. The ozone supplier according to claim 1, wherein the deaerator comprises a bubbling structure which uses an inert gas to bubble the mixed solvent subjected to the removal of the undissolved gas, and an inert gas supplier which supplies the inert gas to the bubbling structure.

7. The ozone supplier according to claim 1, wherein a circulating line is provided between the deaerator and the mixer.

8. A multi-stage type ozone supplier comprising one or more kinds of ozone suppliers according to claim 1 in a plurality of stages in series.

9. The ozone supplier according to claim 1, wherein the fluorine-based solvent is fluorocarbons, fluoroketones, fluoroethers or mixtures thereof.

10. An ozone supplying method comprising:
dissolving an oxygen-ozone mixed gas in a fluorine-based solvent to produce a mixed solution,
removing an excess gas which remains undissolved in the fluorine-based solvent, and
deaerating an ozone-containing gas dissolved in a liquid component in the mixed solution subjected to removal of the excess gas.

11. An ozone supplying method comprising:
dissolving an oxygen-ozone mixed gas in a fluorine-based solvent under a pressure to produce a mixed solution,
removing an excess gas which remains undissolved in the fluorine-based solvent, and
deaerating an ozone-containing gas dissolved in a liquid component by depressurizing the mixed solution subjected to removal of the excess gas.

12. An ozone supplying method comprising:
dissolving an oxygen-ozone mixed gas in a fluorine-based solvent under cooling to produce a mixed solution,
removing an excess gas which remains undissolved in the fluorine-based solvent, and
deaerating the ozone-containing gas dissolved in a liquid component by heating the mixed solution subjected to removal of the excess gas.
